(19) United States
(12) Patent Application Publication
(10) Pub. No.: US 2006/0033604 A1
(43) Pub. Date: Feb. 16, 2006

(54) Network-based remote-control apparatus and network switch for the same

(76) Inventor: Jiun-Chau Tzeng, Taipei City (TW)

Correspondence Address: HDSL, 4331 STEVENS BATTLE LANE, FAIRFAX, VA, 22033, US

(21) Appl. No.: 11/199,068

(22) Filed: Aug. 9, 2005

(30) Foreign Application Priority Data
Aug. 13, 2004 (TW) 093212926

(51) Int. Cl. G05B 23/02

(52) U.S. Cl. 340/3.7; 340/3.1; 340/825.25; 340/825.69

(57) ABSTRACT

A network-based remote-control apparatus and a network switch are proposed. The network-based remote-control apparatus comprises a remote computer, an Internet, a gateway, a server and a network switch. Through the network-based remote-control apparatus, user sends a command signal by using the remote computer and the command signal is sent to the network switch through the Internet. The network switch sends control signal to drive the remote controller inserted to the network switch such that the remote controller sends functional control signal to the electrical appliance to trigger the electrical appliance. Moreover user can also fetch image of the electrical appliance to monitor the operation status of the electrical appliance.

### BACKGROUND OF THE INVENTION

1. Field of the Invention

The present invention relates to a network-based remote-control apparatus and a network switch for the same, especially to a network-based remote-control apparatus enabling user to control at least one electrical appliance trough a remote computer and Internet.

2. Description of Prior Art

Internet is omnipresent for modern people and provides useful tool for accessing information. However, Internet so far does not have sufficient integration with electrical appliances.

For example, people usually controls the electrical appliances remotely by timer or some preset function of the electrical appliances. Alternatively, some electrical appliances can be activated remotely by telephone.

However, this way to activate the electrical appliance cannot be checked by user. For example, the user cannot ensure that the electrical appliance is really turned on remotely, unless he had returned home. Therefore, it is benefic to provide a scheme to start electrical appliance remotely through network such as Internet.

### SUMMARY OF THE INVENTION

The present invention is intended to provide a network-based remote-control apparatus enabling user to control at least one electrical appliance trough a remote computer and Internet, wherein only minimal modification is needed for the existing remote controller of the electrical appliance.

Accordingly, the present invention provides a network-based remote-control apparatus and a network switch are proposed. The network-based remote-control apparatus comprises a remote computer, an Internet, a gateway, a server and a network switch. Through the network-based remote-control apparatus, user sends a command signal by using the remote computer and the command signal is sent to the network switch through the Internet. The network switch sends control signal to drive the remote controller inserted to the network switch such that the remote controller sends functional control signal to the electrical appliance to activate the electrical appliance. Moreover user can also fetch image of the electrical appliance to monitor the operation status of the electrical appliance.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows a block diagram of the network-based remote-control apparatus according to a preferred embodiment of the present invention.

FIG. 2 shows a block diagram of the network switch according to a preferred embodiment of the present invention.

FIG. 3A shows a block diagram of a remote controller according to a preferred embodiment of the present invention.

FIG. 3B shows a block diagram of a remote controller according to another preferred embodiment of the present invention.

FIG. 4 shows a block diagram of the network switch according to a preferred embodiment of the present invention.

### DETAILED DESCRIPTION OF THE INVENTION

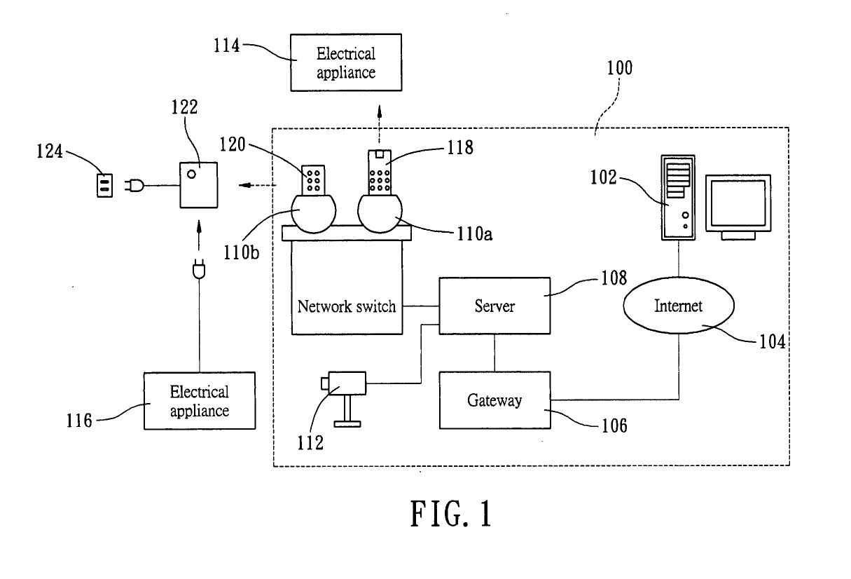

FIG. 1 shows a block diagram of the network-based remote-control apparatus according to a preferred embodiment of the present invention. The network-based remote-control apparatus 100 comprises an Internet 104, a gateway 106, a server 108, a network switch 110 and an image fetcher 112.

In the shown preferred embodiment of the present invention, user sends a command signal through a remote computer 102 and the command signal is sent to the gateway 106 through the Internet 104.

The gateway 106 is electrically connected between the Internet 104 and the server 108 to receive and send the command signal. The server 108 is electrically connected to the gateway 106 to receive and send the command signal to the network switch 110, wherein the server 108 is a commercially available server for security system.

The network switch 110 is electrically connected to the server 108 and comprises a plurality of remote controller sockets, wherein two remote controller sockets 110a and 110b are shown for demonstration. A remote controller 118 is connected with the remote controller socket 10a and a remote controller 120 is connected with the remote controller socket 110b. The network switch 110 receives command signal and then sends the command signal to the remote controller socket 110a or the remote controller socket 110b. Afterward, the remote controller socket 110a or the remote controller socket 110b sends corresponding control signals to respective remote controller 118 or remote controller 120.

The corresponding remote controller 118 or remote controller 120 receives the control signals and then sends functional control signals in wireless way to an electrical appliance 114 or another electrical appliance 116. The functional control signals can be transmitted, for example but not limited to, RF (radio frequency) signal or IR (Infrared) signal.

The image fetcher 112 is electrically connected to the server 108 for fetching an image of the electrical appliance 114 or an image of the electrical appliance 116. The fetched image is sent to the remote computer 102 through the server 108, the gateway 106 and the Internet 104. The remote computer 102 displays the fetched image to manifest user with operation condition of the electrical appliance 114 or the electrical appliance 116.

The electrical appliance 116 can be electrically connected to a power source switch 122, and the power source switch 122 is electrically connected to a power socket 124. The power source switch 122 will selectively supply electrical power to the electrical appliance 116 according the received functional control signal.

The electrical appliance 114 or the electrical appliance 116 can be one of television, electrical lamp, and water spraying device.

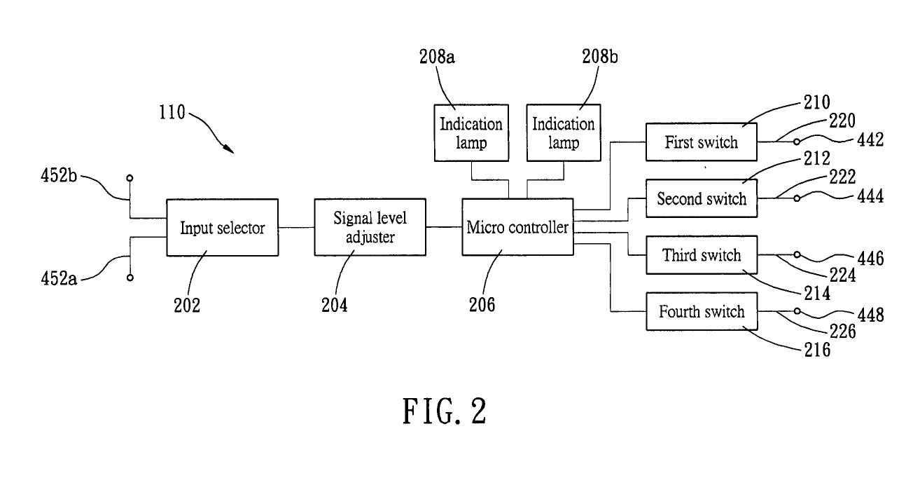

FIG. 2 shows a block diagram of the network switch 110, which comprises an input selector 202, a signal level adjuster 204, a micro controller 206, a first switch 210, a second switch 212, a third switch 214, a fourth switch 216, indication lamps 208a and 208b.

In the shown preferred embodiment, the network switch 110 is connected to a dry contact, a relay output pin or general purpose Input/Output (GPIO) pin of the server 108.

The input selector 202 receives and selects the command signal sent from the dry contact, the relay output pin or the GPIO pin, and then outputs the command signals. The signal level adjuster 204 receives the command signal and sends the command signal to the micro controller 206 after adjusting the level of the command signal.

The micro controller 206 is electrically connected to the signal level adjuster 204 and controls at least one of the switches 210-216 according to the received command signals. The switches 210-216 are selectively turned on by the command signals, and the turning-on sequence and turning-on time thereof are controlled by the micro controller 206.

In the shown preferred embodiment, the indication lamps 208a and 208b are used to indicate normal operation and functional control signal transmitting, respectively. It should be noted in the shown preferred embodiment, only two indication lamps are shown for simplicity.

The fetched image of the image fetcher 112 shown in FIG. 1 can be the state of the electrical appliance 114 and the electrical appliance 116, or the state of the indication lamps 208a and 208b.

According to the preferred embodiment of the present invention, the indication lamps 208a and 208b can be, but not limited to, LED lamps.

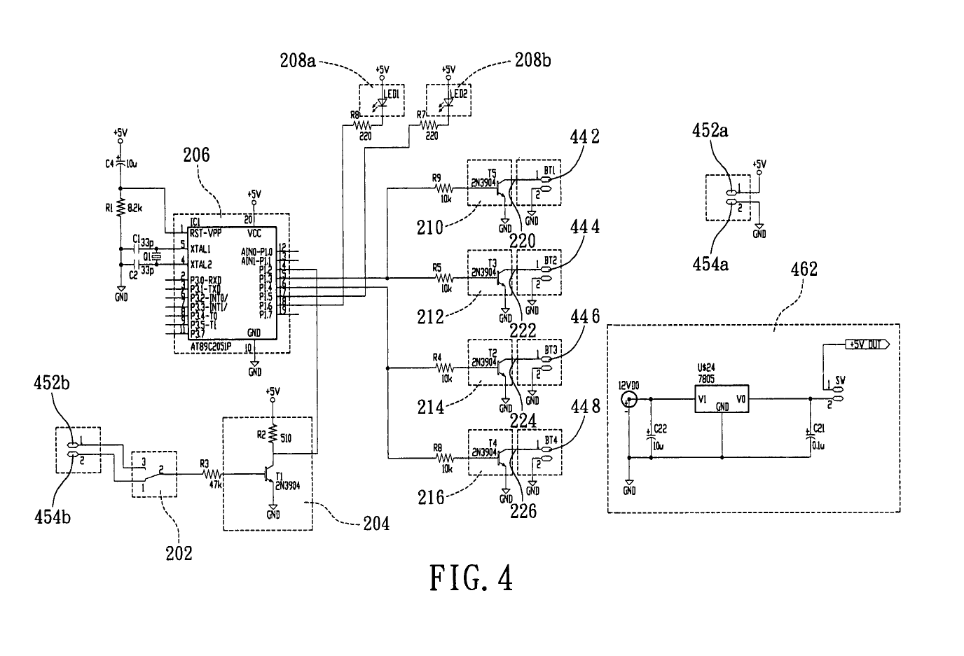

With reference also to FIGS. 2 and 4, a pin 220 is electrically connected to a first contact 442, a pin 222 is electrically connected to a second contact 444, a pin 224 is electrically connected to a third contact 446 and a pin 226 is electrically connected to a fourth contact 448.

According to the preferred embodiment of the present invention, the first contact 442 and the third contact 446, for example, can be together formed within the same remote controller socket 110a or the remote controller socket 110b. The first contact 442 and the third contact 446 are used for communication with the corresponding remote controller 118 or remote controller 120 as shown in FIG. 1.

Moreover, as shown in FIG. 4, the dry contact (or the relay output pin) in the server 108 is electrically connected to a contact 452a and a contact 452b, and the contact 452b is electrically connected to the input selector 202. Similarly, the GPIO pin of the server 108 shown in FIG. 1 is electrically connected to a contact 454a and a contact 454b, and the contact 454b is electrically connected to the input selector 202. Therefore, the input selector 202 can selectively get input source from the dry contact (or the relay output pin) or the GPIO pin in the server 108 shown in FIG. 1.

Moreover, the unit labeled with numeral 462 is an operation power source 462 for providing operation power.

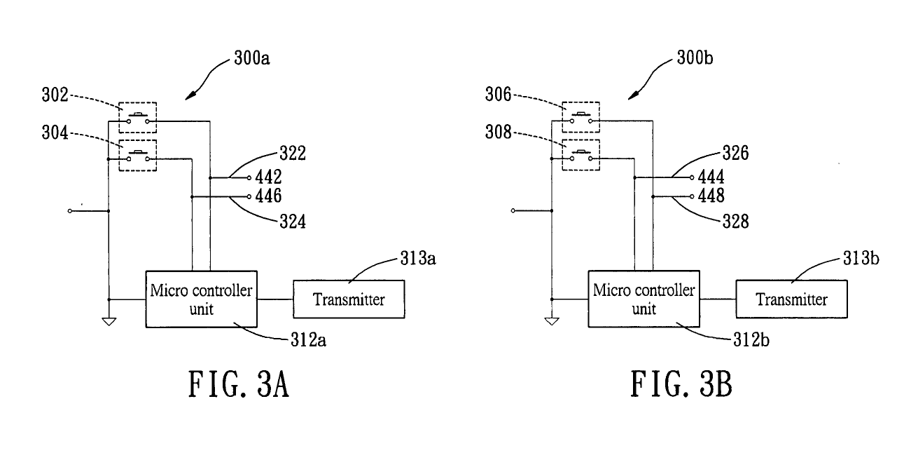

With reference again to FIGS. 3A and 3B, two remote controllers 300a and 300b are shown in those figures. The remote controller 300a comprises a micro controller unit 312a, controller buttons 302 and 304 (only two buttons 302 and 304 are shown for illustration purpose), controller contacts 322 and 324 and a transmitter 313a.

When the controller contacts 322 and 324 are not in contact with the first contact 442 and the third contact 446 shown in FIG. 4, namely when the remote controller 300a is not inserted into the remote controller socket 110a, the user presses the controller buttons 302 and 304 on the remote controller 300a to send command to the micro controller unit 312a. Therefore, the micro controller unit 312a controls the transmitter 313a to send user command, such as functional control signals.

When the controller contacts 322 and 324 are in contact with the first contact 442 and the third contact 446 shown in FIG. 4, namely when the remote controller 300a is inserted into the remote controller socket 10a, the micro controller unit 321a receives the control signals sent through the first contact 442 and the third contact 446 and then sends the functional control signals to the electrical appliance 114 and the electrical appliance 116 shown in FIG. 1 after processing the control signals.

Moreover, the remote controller 300b shown in FIG. 3B comprises a micro controller unit 312b, controller buttons 306 and 308 (only two buttons 306 and 308 are shown for illustration purpose), controller contacts 326 and 328 and a transmitter 313b. The controller contacts 326 and 328 are in contact with the second contact 444 and the fourth contact 448 shown in FIG. 4.

According to the preferred embodiment of the present invention, the remote controller 300b has similar operation with the remote controller 300a shown in FIG. 3A, therefore, the description thereof is omitted here for simplicity.

To sump up, the network-based remote-control apparatus according to the present invention enables a remote user to monitor local electrical appliance through Internet and a remote computer. The user can control and supervise function and status of the local electrical appliance. Moreover, the user also can activate the local electrical appliance remotely to cheat burglar.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A network-based remote-control apparatus using a remote controller to send at least one functional signal to control at least one local electrical appliance, the network-based remote-control apparatus comprising:
a computer to send a command signal;
an Internet electrically connected to the computer for conveying the command signal;
a server electrically connected to the Internet, the server receiving and sending the command signal;
an image fetcher electrically connected to the server and sending a fetched image to the computer; and
a network switch electrically connected to the server and receiving the command signal to control the remote controller for outputting a functional control signal.

2. The network-based remote-control apparatus as in claim 1, further comprising a gateway electrically connected between the Internet and the server and used to receive and send the command signal.

3. The network-based remote-control apparatus as in claim 1, wherein the network switch comprises a plurality of remote controller sockets for connecting with remote controllers and controlling the remote controllers to sequentially send the functional control signal.

4. The network-based remote-control apparatus as in claim 3, wherein the electrical appliance is controlled by the functional control signal.

5. The network-based remote-control apparatus as in claim 3, wherein the functional control signal is an RF signal.

6. The network-based remote-control apparatus as in claim 3, wherein the functional control signal is an IR signal.

7. The network-based remote-control apparatus as in claim 1, further comprising a power source switch controlled by the functional control signal to control an electrical power supplied to the electrical appliance.

8. The network-based remote-control apparatus as in claim 7, wherein the power source switch comprises another end connected to a power socket.

9. A network switch comprising
a signal level adjuster receiving a command signal and outputting the command signal after adjusting a level of the command signal;
a micro controller electrically connected to the signal level adjuster and sending a control signal according to the command signal; and
a plurality of switches electrically connected to the micro controller unit and being turned on when receiving the control signal; wherein turning-on time and turning-on sequence is controlled by the micro controller.

10. The network switch as in claim 9, further comprising
an input selector electrically connected to the signal level adjuster to select one signal source for the command signal and output the command signal.

11. The network switch as in claim 10, wherein the signal source comprises GPIO pin.

12. The network switch as in claim 10, wherein the signal source comprises dry contact.

13. The network switch as in claim 10, wherein the signal source comprises relay output pin.

14. The network switch as in claim 9, further comprising
a plurality of indication lamps electrically connected to the micro controller to indicate whether the control signal is for activation.

15. The network switch as in claim 9, further comprising
a plurality of remote controller sockets electrically connected to the switches and into which the plurality of remote controllers are inserted.

16. The network switch as in claim 15, wherein any of the remote controllers sends a functional control signal after receiving the control signal.

17. The network switch as in claim 16, wherein the functional control signal is an RF signal.

18. The network switch as in claim 16, wherein the functional control signal is an IR signal.

19. The network switch as in claim 9, wherein the switches comprise a first contact, a second contact, a third contact and a fourth contact in connection with the remote controller respectively.
